(19) United States
(12) Patent Application Publication
(10) Pub. No.: US 2023/0058107 A1
(43) Pub. Date: Feb. 23, 2023

(54) DECORATED ALUMINUM BASE MATERIAL PRODUCTION METHOD AND DECORATED ALUMINUM BASE MATERIAL

(71) Applicant: TOYO SEIKAN CO., LTD., Tokyo (JP)

(72) Inventors: Ryotaro ISOMURA, Chiba (JP); Shuji NAKANO, Kanagawa (JP); Satoru KITO, Kanagawa (JP); Atsushi KOMINAMI, Kanagawa (JP)

(73) Assignee: TOYO SEIKAN CO., LTD., Tokyo (JP)

(21) Appl. No.: 17/797,170

(22) PCT Filed: Dec. 22, 2020
(86) PCT No.: PCT/JP2020/048024

§ 371 Date: Aug. 3, 2022

(30) Foreign Application Priority Data
Feb. 6, 2020 (JP) 2020-018747

(51) Int. Cl. B44C 1/22; B65D 1/12; B65D 1/40

(52) U.S. Cl. CPC B44C 1/228; B65D 1/12; B65D 1/40

(57) ABSTRACT

With a laser decoration method for forming a painting film layer on a surface of a metal base material, and irradiating the painting film layer with a laser beam LB, thereby applying decoration, the decoration part is effectively colored by a simple process, which enables decoration with high visibility while omitting a complicated process. The problem was solved by a production method of a decorated aluminum base material characterized by including a process of forming a painting film layer on a surface of an aluminum base material, a process of partially exposing the surface of the aluminum base material by irradiation with a laser beam, and a process of subjecting the surface of the aluminum base material to an oxide film forming treatment, wherein a colored oxide film is formed on the exposed surface of the aluminum base material by the oxide film forming treatment.

### TECHNICAL FIELD

The present invention relates to an aluminum base material including a can or the like.

### BACKGROUND ART

A metal base material including a painting film formed on the surface thereof is irradiated with a laser beam, thereby performing decoration such as marking. This is performed on various kinds of products. As one related art, the technology is known in which when irradiation with a laser beam is performed with the film formed on the surface of the metal base material set as a thick film, the thick film is removed to a depth not reaching the surface of the metal base material, thereby performing marking (see the following PTL 1).

### CITATION LIST

### Patent Literature

[PTL 1] Japanese Patent Application Publication No. 2003-181658

### SUMMARY OF INVENTION

### Technical Problem

With the related art, when the painting film on the metal base material surface is a monolayer, a part of the monolayer is cut by a laser beam, resulting in the formation of a groove, which enables decoration of letter or the like. However, the difference in color is less likely to be distinguished between the decoration part and the non-decoration part. For this reason, decoration with high visibility is undesirably less likely to perform. For this, the painting film is configured in two layers in which the color is varied between the first layer and the second layer. As a result, decoration can be performed with different colors. However, configuration of the painting film in two layers undesirably results in a complicated painting film process.

It is an object of the present invention to deal with such a problem. Namely, the objects of the present invention are as follows: with a laser decoration method for forming a painting film layer on the surface of the metal base material, and irradiating the painting film layer with a laser beam, thereby performing decoration, the decoration part is subjected to effective coloring by a simple process; this enables decoration with high visibility while omitting a complicated process, and other objects.

### Solution to Problem

In order to solve such a problem, the present invention includes the following configuration.

A production method of a decorated aluminum base material characterized by including:

forming a painting film layer on a surface of an aluminum base material;

partially exposing the surface of the aluminum base material by irradiation with a laser beam; and

subjecting an exposed surface of the aluminum base material to an oxide film forming treatment, wherein

a colored oxide film is formed on the exposed surface of the aluminum base material by the oxide film forming treatment.

Further, in another aspect, the problem was solved by configuring a metal container material characterized by including an aluminum base material and a painting film layer, wherein the aluminum base material includes the painting film layer formed on a surface thereof, and the painting film layer has a part from which the painting film layer has been removed, and the part becomes a colored oxide coating.

### Advantageous Effects of Invention

In accordance with the production method of an aluminum base material of the present invention having such features, with a laser decoration method for forming a painting film layer on the surface of the metal base material, and irradiating the painting film layer with a laser beam, thereby performing decoration, the decoration part can be subjected to effective coloring by a simple process, and decoration with high visibility can be obtained while omitting a complicated process.

Further, with the metal container material of the present invention, it is possible to provide a metal container material using a new principle of decoration.

### BRIEF DESCRIPTION OF DRAWINGS

FIG. 1 is an explanatory view showing a laser decoration method in accordance with an embodiment of the present invention.

FIG. 2 is a photograph of a sample showing the results of Experiment 1.

FIG. 2 at (a) is a sample before an oxide coating forming process.

FIG. 2 at (b) is a sample after the oxide coating forming process using treatment water 1 (pure water).

FIG. 2 at (c) is a sample after the oxide coating forming process using treatment water 2 (commercially available mineral water A (pH 6.9)).

FIG. 2 at (d) is a sample after the oxide coating forming process using treatment water 3 (commercially available mineral water B (pH 7.5)).

FIG. 3 is a photograph of a sample showing the results of Experiment 2.

FIG. 3 at (a) is a sample before the oxide coating forming process.

FIG. 3 at (b) is a sample after the oxide coating forming process using treatment water 1 (pure water).

FIG. 3 at (c) is a sample after the oxide coating forming process using treatment water 4 (a buffer solution including a substance added therein with a pH of 7.1).

FIG. 4 is a photograph of a sample showing the results of Experiment 3.

FIG. 4 at (a) is a sample before the oxide coating forming process.

FIG. 4 at (b) is a sample after the oxide coating forming process using treatment water 1 (pure water).

FIG. 4 at (c) is a sample after the oxide coating forming process using treatment water 5 (industrial water with an iron concentration of 0.3 ppm).

FIG. 4 at (d) is a sample after the oxide coating forming process using treatment water 6 (industrial water with an iron concentration of less than 0.1 ppm).

FIG. 5 is a photograph of a sample showing the results of Experiment 4.

FIG. 5 at (a) is a sample before the oxide coating forming process.

FIG. 5 at (b) is a sample after the oxide coating forming process using treatment water 1 (pure water).

FIG. 5 at (c) is a sample after the oxide coating forming process using treatment water 7 (a silicon concentration of less than 1 ppm).

FIG. 5 at (d) is a sample after the oxide coating forming process using treatment water 8 (a silicon concentration of 2 ppm).

FIG. 5 at (e) is a sample after the oxide coating forming process using treatment water 9 (a silicon concentration of 4 ppm).

FIG. 5 at (f) is a sample after the oxide coating forming process using treatment water 10 (a silicon concentration of 24 ppm).

### DESCRIPTION OF EMBODIMENTS

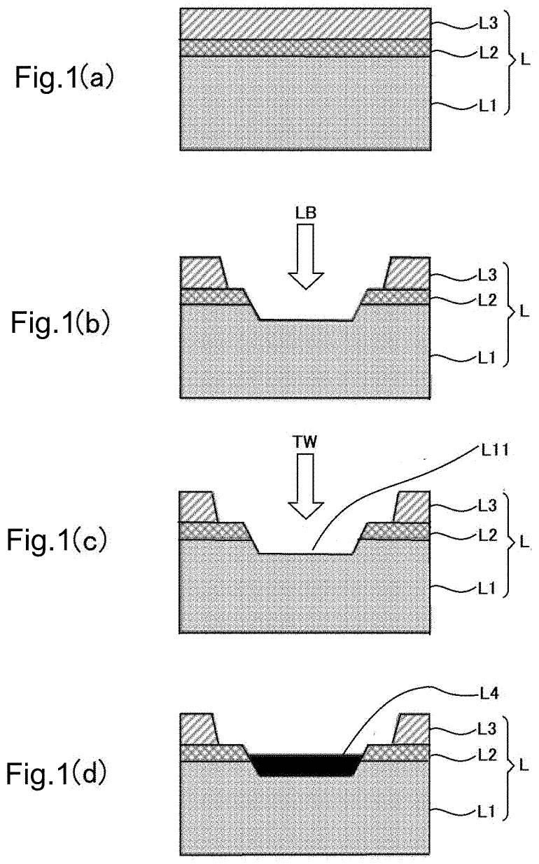

Below, with reference to the accompanying drawings, embodiments of the present invention will be described. With a laser decoration method in accordance with an embodiment of the present invention, a metal container material L as shown in FIG. 1 is subjected to laser decoration. The metal container material L is obtained by forming a painting film layer L3 on an aluminum base material L1 via an appropriate surface treatment layer L2. Such a metal container material L is for forming a can container filled with food such as beverage, an aerosol can filled with a liquid material for life/household uses, and the like.

For such a metal container material L, a decoration such as a letter or a pattern is applied to the painting film layer L3. However, the decoration related to the individual information of a product or the like is applied after formation into a can. For this reason, laser decoration capable of performing decoration without deforming the can is performed.

With a laser decoration method in accordance with an embodiment of the present invention, the metal container material L as shown in FIG. 1 at (a) is irradiated with a laser beam LB, thereby removing a part of the painting film layer L3 (and the surface treatment layer L2), and partially exposing the surface of the aluminum base material L1 as shown in FIG. 1 at (b). Then, as shown in FIG. 1 at (c), the exposed aluminum base material L1 (surface exposure part L11) is subjected to an oxide film forming treatment using treatment water TW, thereby forming a colored oxide film on the exposed aluminum base material L1 as shown in FIG. 1 at (d). The color herein becomes a color with lower brightness than that of the color of the aluminum base material L1 such as black, brown, or gray.

At this step, for the painting film layer L3, a material, a film thickness, or the like which results in effective exposure of the aluminum base material L1 by irradiation with the laser beam LB is preferably selected. For the color of the painting film layer L3, the color resulting in a high contrast with the colored oxide film formed at the decoration part is preferably selected.

Particularly, when the painting film layer L3 is irradiated with the laser beam LB, thereby performing decoration, by appropriately selecting the color of the painting film layer L3 by the wavelength and the output of the laser beam LB, the laser beam LB becomes more likely to reach the underlying layer of the painting film layer L3. As a result, the surface treatment layer L2 can be removed, so that the surface of the aluminum base material L1 can be effectively exposed. When a fiber laser with a wavelength of about 1000 nm is used as the laser beam LB, the surface of the aluminum base material L1 can be effectively exposed with a color except for black or a transparent color.

As the treatment water TW for use in performing the oxide film forming treatment, the one including an effective component for forming a colored oxide film is used. Silicon, potassium, magnesium, calcium, iron, or zinc has been proved to form a colored oxide coating. For this reason, as the effective components, mention may be made of metal ions of silicon, potassium, magnesium, calcium, iron, and zinc. One or a plurality of the components are preferably included therein. Particularly, as the component which tends to form a black oxide film, silicon may be mentioned.

Further, the treatment water TW can accelerate the oxidation reaction when heated. For this reason, 50° C. or hotter, preferably 70° C. or hotter, and further preferably 80° C. or hotter water is preferably used. Further, the treatment water TW preferably has a pH of 6.5 or more for accelerating the oxidation reaction.

When the metal container material L is a material for the container for food, after forming the container, a hot water sterilization process (e.g., retort sterilization) and a cooling process are performed. For the water for use in this step, the one obtained by heating tap water or groundwater is often used. The tap water or groundwater generally includes silicon. For this reason, the hot water sterilization process of the container for food can also serve as the oxide film forming treatment for decoration. Further, an aerosol container is subjected to warm water inspection. Also for the water for use in this step, about 40 to 60° C. tap water or groundwater is often used. For this reason, the warm water inspection of the aerosol container can also serve as the oxide film forming treatment for decoration.

As indicated from the principle described up to this point, any material is included in the aluminum base material of the present invention so long as it is configured such that aluminum or an aluminum alloy is exposed even partially on the surface, and a painting film layer can be formed thereon. Further, even a laminated body of a different metal from aluminum is included in the “aluminum base material” of the present invention so long as it is configured such that the surface is aluminum capable of forming a painting film layer thereon. Furthermore, the aluminum base material may be processed into a can or the like, or may be in a sheet shape, and the shape and the degree of processing thereof do not matter.

Further, any material for the painting film layer is acceptable, and the coating means for forming the painting film layer does not matter.

### Experiment 1

Experiment 1 is the experiment for examining the influence of the substance included in the treatment water TW.

### [Pretreatment of Sample]

A plate including an aluminum base material L3 including a surface treatment layer L2 formed thereon by performing a chromate-phosphate treatment (CP treatment) was prepared. The plate was coated with a red paint in order to form a painting film layer L3 on the surface treatment layer L2. Then, the plate was subjected to laser decoration so as to be formed into a star-shaped pattern using a laser beam LB (a fiber laser beam with a wavelength of 1064 nm). As a result, a plurality of star-shaped decoration regions were formed on the surface of the plate. In each star-shaped decoration region, the painting film layer 13 disappeared, and the surface of the aluminum base material L1 was exposed, resulting in a surface exposure part L11.

A plurality of samples subjected to such a pretreatment were formed.

### [Treatment Water]

In Experiment 1, as the treatment water TW, treatment water 1 to treatment water 3 were prepared.

Treatment water 1: pure water (pH 5.6)
Treatment water 2: commercially available mineral water A (pH 6.9)
Treatment water 3: commercially available mineral water B (pH 7.5)

Incidentally, pure water does not include ions at all, and hence scarcely has the electric conductivity, and is a liquid difficult to measure in terms of pH in the first place. It is known that pure water takes in carbonic acid gas or the like in air, and comes to have a pH of about 5.6 after contact with air for a sufficient time. The pH measured for pure water is shown as reference.

### [Conditions for Oxide Coating Forming Process]

The three kinds of treatment waters were placed in different beakers, respectively. Then, the samples were immersed in their respective treatment waters. The opening of each beaker was covered with aluminum foil. The conditions for the oxide coating forming process were the conditions of 125° C. and 30 minutes using an autoclave for promoting the oxidation.

### [Results of Experiment 1]

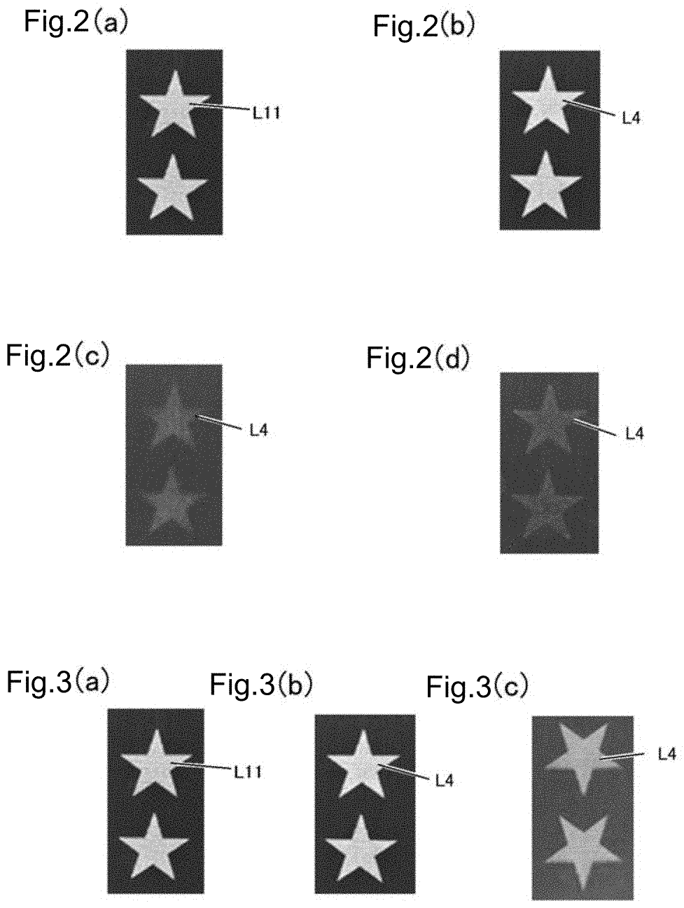

FIG. 2 is a photograph of a sample showing the results of Experiment 1. FIG. 2(a) is a photograph of a sample before the oxide coating forming process, and the photograph before the formation of the oxide coating L4. The drawing is shown as a control experiment.

FIG. 2(b) is a photograph of a sample after the oxide coating forming process using the treatment water 1 (pure water). When the treatment water 1 (pure water) is used, as compared with the sample before the oxide coating forming process, the color of the oxide film L4 hardly changed, and a colorless oxide coating L4 was formed.

FIG. 2(c) is a photograph of a sample after the oxide coating forming process using the treatment water 2 (commercially available mineral water A (pH 6.9)), and FIG. 2(d) is a photograph of a sample after the oxide coating forming process using the treatment water 3 (commercially available water B (pH 7.5)).

In both Experiments using the treatment water 2 and the treatment water 3, it was observed that, as compared with before the oxide coating forming process, a black oxide coating L4 was formed.

It has been proved that, even with the substance in an amount as much as that included in mineral water, the surface exposure part L11 of the aluminum base material L1 becomes a colored oxide coating L4 by the oxide coating forming process.

### Experiment 2

Then, the treatment water 4 was formed, thereby performing an experiments. Treatment water 4: a buffer solution with a pH of 7.1 prepared by adding disodium hydrogen phosphate and sodium dihydrogen phosphate

### [Results of Experiment 2]

FIG. 3 is a photograph of a sample showing the results of Experiment 2. FIG. 3 at (a) is a photograph of a sample before the oxide coating forming process, and FIG. 3 at (b) is a photograph of a sample after the oxide coating forming process using the treatment water 1 (pure water). FIG. 3 at (a) and (b) is shown as controls.

FIG. 3 at (c) is a photograph of a sample after the oxide coating forming process using the treatment water 4 (a buffer solution with a pH of 7.1), and indicates that the sample was tarnished in a slightly black color as compared with the controls.

From the observation of tarnish with a pH of 7.1, it has been presumed that a pH of 6.5 or more will result in tarnish also with all the results of Experiment 1 considered.

### Experiment 3

It is an object of Experiment 3 to examine the relationship between the concentration of iron and the tarnish of the oxide coating L4. The conditions for the oxide coating forming process were set the same as those for Experiment 1.

Treatment water 5: industrial water with an iron concentration of 0.3 ppm
Treatment water 6: industrial water with an iron concentration of less than 0.1 ppm

### [Results of Experiment 3]

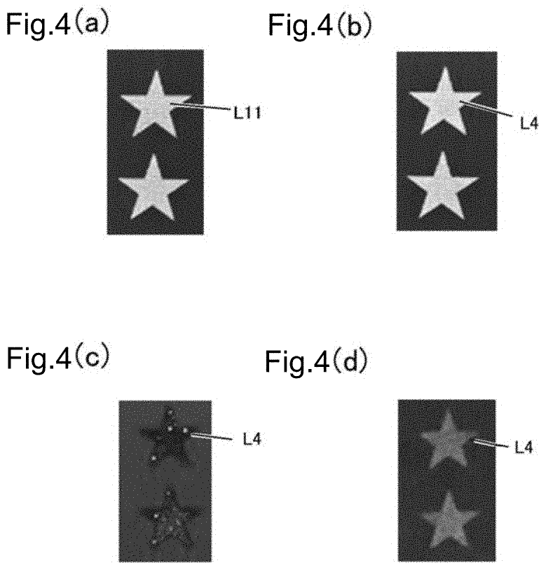

FIG. 4 is a photograph of a sample showing the results of Experiment 3. FIG. 4 at (a) is a sample before the oxide coating forming process, and FIG. 4 at (b) is a sample after the oxide coating forming process using the treatment water 1 (pure water). FIG. 4 at (a) and (b) is shown as controls.

FIG. 4 at (c) is a photograph of a sample after the oxide coating forming process using the treatment water 5 (industrial water with an iron concentration of 0.3 ppm), and indicates that the degree of tarnish of the oxide coating L4 was large, and the sample was tarnished in a black color. FIG. 4 at (d) is a photograph of a sample after the oxide coating forming process using the treatment water 6 (industrial water with an iron concentration of less than 0.1 ppm), and indicates the state in which the sample was tarnished in black even though the degree of tarnish was not as much as that of FIG. 4 at (c).

The Experiment 3 has proved that, with an increase in concentration of iron, the degree of tarnish of the oxide coating L4 increases, resulting in tarnishing into a black color.

### Experiment 4

It is an object of Experiment 4 to examine the relationship between the concentration of silicon and the tarnish of the oxide coating L4. The conditions for the oxide coating forming process were set the same as that for Experiment 1.

A silicon dioxide powder was added in an excessive amount to pure water with stirring, and further an autoclave treatment was performed at 125° C. for 60 minutes. Then, the silicon dioxide powder left without being dissolved was removed by filtration, thereby manufacturing silicon-containing water.

The silicon-containing water was diluted with pure water, thereby preparing treatment water TW with the following concentration. The pH was adjusted to a pH of 7.5 by addition of sodium hydrogen carbonate.

Treatment water 7: prepared water with a silicon concentration of less than 1 ppm
Treatment water 8: prepared water with a silicon concentration of 2 ppm
Treatment water 9: prepared water with a silicon concentration of 4 ppm
Treatment water 10: prepared water with a silicon concentration of 24 ppm

### [Results of Experiment 4]

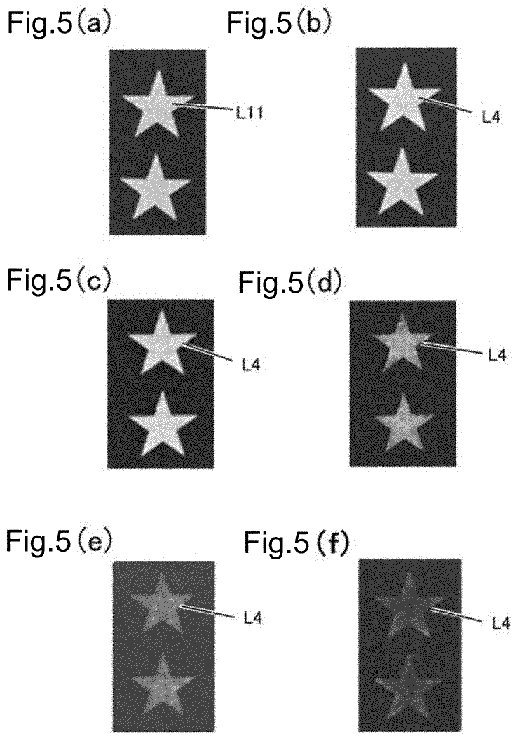

FIG. 5 is a photograph of a sample showing the results of Experiment 4.

FIG. 5 at (a) is a photograph of a sample before the oxide coating forming process, and FIG. 5 at (b) is a sample after the oxide coating forming process using the treatment water 1 (pure water). FIG. 5 at (a) and (b) is shown as controls.

FIG. 5 at (c) is a photograph of a sample after the oxide coating forming process using the treatment water 7 (silicon concentration of less than 1 ppm), and indicates that the degree of tarnish of the oxide coating L4 scarcely as compared with those of the controls. FIG. 5(d) is a photograph of a sample after the oxide coating forming process using the treatment water 8 (silicon concentration of 2 ppm), and indicates that the oxide coating L4 is tarnished in a slightly black color as compared with the controls. FIG. 5(e) is a photograph of a sample after the oxide coating forming process using the treatment water 9 (silicon concentration of 4 ppm), and indicates that the oxide coating L4 is clearly tarnished in a black color as compared with the controls. FIG. 5(f) is a photograph of a sample after the oxide coating forming process using the treatment water 10 (silicon concentration of 24 ppm), and indicates that the oxide coating L4 is tarnished in a pretty black color as compared with the controls.

### (Degree of Decoration)

In the Experiments 1 to 4, the conditions were variously changed, thereby tarnishing the oxide coating L4, and thus performing decoration. Out of these, the degree of tarnish of each oxide coating L4 of some samples (such as FIG. 5(d)) was weak. However, the oxide coating L4 can be purposely used as the one with a weak degree of tarnish. This can be used, for example, in the case of printing of information unnecessary for a consumer. Printing of unnecessary information conspicuously results in damaged designability. The usage is advantageous for printing information unnecessary for consumers such as a lot number on the lid body of a metal can, or the like.

Further, the “decoration (print)” is not limited to letters, but includes a design, a pattern, a bar code, a two-dimensional code, mechanically readable information, and the like. Further, the intended purpose of decoration (print) does not matter.

### (Temperature)

Experiment was performed under the conditions of 125° C. and 30 minutes using an autoclave as the conditions for the oxide coating forming process. This is the conditions set for promoting the oxide coating forming reaction, and examining the effect of the hot water sterilization process (e.g., retort sterilization).

### Experiment 5

Experiment was performed which examines the relationship between the temperature and the time until a colored oxide coating L4 with sufficient visibility is formed.

The color difference of the marked part was measured using a flexographic spectrophotometer eXact.

As a control experiment, L* after the heat treatment was measured with reference to L* of the oxide coating L4 not tarnished to be colored before the heat treatment, and the reduction value of L* was evaluated.

For marking, an aluminum plate marked using a laser beam LB (a fiber laser beam with a wavelength of 1064 nm) was immersed in each treatment water, and was heated in a thermostat.

### [Results of Experiment 5]

TABLE 1

| | Time required until the L* value is reduced (min) | | | | |
|---|---|---|---|---|---|
| ΔL* | 5 | 10 | 15 | 20 | 30 |
| 50° C. tap water | 141 | 324 | 506 | 689 | 1054 |
| 70° C. tap water | 5 | 29 | 61 | 93 | 156 |
| 80° C. tap water | 3 | 11 | 30 | 49 | 87 |
| 90° C. tap water | 2 | 5 | 9 | 20 | 41 |
| 100° C. tap water | 1 | 4 | 5 | 11 | 21 |

It has been proved that, when the temperature becomes 70° C. or more, obviously, the degree of tarnish increases, and the speed of tarnishing also increases.

Incidentally, in Example, the means by the laser beam LB was used in order to enhance the efficiency for removing the painting film layer L3. However, any means can be used even if the efficiency is inferior so long as it can remove the painting film layer L3 and can form the surface exposure part L11.

As described up to this point, the laser decoration method in accordance with the embodiment of the present invention can perform laser decoration with a high contrast and high visibility by coloring the decoration part in a black color or the like without performing a time-consuming coloring process. With the laser decoration method in accordance with the embodiment of the present invention, to a container requiring sterilization such as a can filled with food, the hot water sterilization process also serves as the oxide film forming treatment, so that decoration with good visibility can be applied with efficiency. Also to an aerosol can, the warm water inspection process can also serve as the oxide film forming treatment, so that decoration with high visibility can be applied with efficiency.

### REFERENCE SIGNS LIST

L Metal container material
L1 Aluminum base material
L11 Surface exposure part
L2 Surface treatment layer
L3 Painting film layer
L4 Oxide coating
LB Laser beam
TW Treatment water

1. A production method of a decorated aluminum base material, comprising:
forming a painting film layer on a surface of an aluminum base material;
partially exposing the surface of the aluminum base material by irradiation with a laser beam; and
subjecting an exposed surface of the aluminum base material to an oxide film forming treatment,
wherein a colored oxide film is formed on the exposed surface of the aluminum base material by the oxide film forming treatment.

2. The production method of the decorated aluminum base material according to claim 1,
wherein a color of the oxide film is a color with lower brightness than a color of the aluminum base material.

3. The production method of the decorated aluminum base material according to claim 1,
wherein the oxide film forming treatment uses treatment water including at least one selected from a group consisting of silicon, potassium, magnesium, calcium, iron, and zinc.

4. The production method of the decorated aluminum base material according to claim 3,
wherein the treatment water has a pH of 6.5 or more.

5. The production method of the decorated aluminum base material according to claim 3,
wherein a temperature of the treatment water is 50° C. or more.

6. The production method of the decorated aluminum base material according to claim 1,
wherein the aluminum base material is a can, and
the oxide film forming treatment also serves as a hot water sterilization process of the can.

7. The production method of the decorated aluminum base material according to claim 1,
wherein the aluminum base material is an aerosol container, and
the oxide film forming treatment also serves as warm water inspection of the aerosol container.

8. A container material comprising an aluminum base material and a painting film layer,
wherein the aluminum base material includes the painting film layer formed on a surface thereof and
the painting film layer has a part from which the painting film layer has been removed, and the part becomes a colored oxide coating.

9. The container material according to claim 8,
wherein the container material is a lid body of a can.

10. The container material according to claim 8,
wherein the container material is a can body of a can.

11. The container material according to claim 8,
wherein the container material is a can body of an aerosol container.

12. A container comprising the container material according to claim 1, and filled with contents.
